(19) United States
(12) Patent Application Publication
(10) Pub. No.: US 2019/0284439 A1
(43) Pub. Date: Sep. 19, 2019

(54) Adhesive tape for jacketing elongate items such as especially cable harnesses and method for jacketing

(71) Applicant: tesa SE, Norderstedt (DE)

(72) Inventors: Patrick KEREP, Hamburg (DE); Georg SCHMIEDEL, Hamburg (DE); Mark HÄNLE, Norderstedt (DE); David MARANGOS, Hamburg (DE)

(21) Appl. No.: 16/354,431

(22) Filed: Mar. 15, 2019

(30) Foreign Application Priority Data
Mar. 16, 2018 (DE) 10 2018 204 019.2

(51) Int. Cl. C09J 7/21; C09J 7/38

(52) U.S. Cl. CPC C09J 7/21; C09J 7/385; C09J 2400/263; C09J 2433/006; C09J 2203/302

(57) ABSTRACT

An adhesive tape in particular for wrapping cables, consisting of a preferably textile carrier and of a pressure sensitive adhesive, applied on at least one side of the carrier, in the form of a dried and crosslinker-free polymer dispersion, the polymer having been synthesized from:
(a) 97.0 to 98.0 wt % of n-butyl acrylate and/or 2-ethylhexyl acrylate
(b) 2.0 to 3.0 wt % of an ethylenically unsaturated monomer having an acid or acid-anhydride function.

This application claims priority of German Patent Application No. 10 2018 204 019.2, filed Mar. 16, 2018, the entire contents of which are incorporated by reference herein.

The invention pertains to an adhesive tape for jacketing elongate items such as more particularly cable harnesses in motor vehicles, and to methods for jacketing.

Adhesive tapes have long been used in the industry for producing cable looms. In this utility, the adhesive tapes serve to bundle a multiplicity of electrical leads prior to installation or in the as-installed state, in order to reduce, by bandaging, the space taken up by the bundle of leads, and also, in addition, to obtain protective functions.

The testing and classifying of adhesive tapes for cable jacketing is accomplished in the motor vehicle industry according to extensive bodies of standards, such as, for example, LV 312-1 “Protective systems for wire harnesses in motor vehicles, adhesive tapes; Test Guideline” (October 2009), as a joint standard of the companies Daimler, Audi, BMW and Volkswagen, or the Ford specification ES-XU5T-1A303-aa (Revised version September 2009) “Harness Tape Performance Specification”. Below, these standards are referred to in abbreviated form as LV 312 and Ford specification, respectively.

Noise suppression, abrasion resistance and also the temperature stability of an adhesive tape are determined on the basis of defined test constructions and test methods, as described comprehensively in LV 312.

Cable wrapping tapes with film carriers and textile carriers are widespread, and are generally coated on one side with various pressure sensitive adhesives.

As well as a range of requirements, such as chemical compatibility, high peel adhesion, compatibility with varying substrates, that are imposed on adhesive tapes, it must also be ensured in the motor vehicle industry that uneven, non-uniform substrates are reliably bonded by the cable runs, convoluted tubes and branches. Other factors are flexural and tension stresses in the course of production, installation and subsequent use within the engine compartment of a motor vehicle, or else in the vehicle body, with continual flexural stress during opening of doors.

Since the end of the adhesive tape is ideally bonded to its own reverse face, there must be good instantaneous peel adhesion (tack) to this substrate, so that flagging of the adhesive tape does not occur at the start. In order to ensure a flagging-free product durably, the anchoring on the substrate and the internal strength of the adhesive must both be such that the adhesive bond is robust even under the effect of tension (tensile and flexural stressing).

In the wrapping of a cable loom, the adhesive tape is bonded with from no overlap at all to complete overlap around the cable, the radius of which is generally small, meaning that the adhesive tape is very sharply curved. At the end of a wrapped section, the tape is typically wrapped primarily onto its own reverse face, so that the degree of overlapping is virtually complete, similar to the customary presentation form of an adhesive tape roll, where the adhesive is likewise bonded to its own reverse face. In the event of flagging, static forces act, for example, through the flexural stiffness of the carrier and the wrapping tension, and may result in the open ends of adhesive tapes standing up undesirably, similar to the start of automatic unwinding. The flagging resistance, then, is the capacity of the adhesive to resist this static force.

Flagging, in the case of an adhesive tape wound around a body—means the tendency of one end of the adhesive tape to stick up. The cause is the combination of holding power by the adhesive, the stiffness of the carrier, and the diameter of the cable loom.

Determining the flagging resistance of Wire Harnessing (WH) cable wrapping tapes is done via the TFT method (Threshold Flagging Time). The target variable for an outstandingly flagging-free woven fabric product is defined as a limiting value of well above 1000 min TFT, preferably above 2000 min TFT.

An alternative method is the SWAT method, as explained below.

The adhesive tape is to protect the leads from damage by abrasion at sharp edges, for example. Accordingly, carrier materials used in particular have an appropriate robustness. The adhesive tapes are therefore classed, in accordance with LV 312, into abrasion classes A to E.

The cable insulation must not become brittle as a result of the effect of the adhesive tape in combination with elevated temperature over a prolonged period. A distinction is made here, inter alia, in accordance with LV 312, inter alia, between four temperature classes T1 to T4, corresponding to 80° C. (also called temperature class A), 105° C. (also called temperature class B(105)), 125° C. (also called temperature class C) and 150° C. (also called temperature class D) which the wrapped cables are required to withstand for 3000 h without embrittlement. It is self-evident that temperature classes T3 and T4 place higher demands on the adhesive tape than the lower classes T1 and T2. Allocation to T1 to T4 is decided not only by the cable insulation material but also by pressure sensitive adhesive and type of carrier.

LV 312 investigates diverse cable insulations. T3-PVC cable insulations are not mentioned in LV 312, but have currently gained in importance within the cable wrapping sector.

Cable wrapping tapes with pressure sensitive adhesives based on natural rubber usually exhibit good flagging resistance, but have an unwind force which increases over the storage time, and particularly so in the case of increasing temperatures. Furthermore, they meet only the lower temperature classes for cable compatibility. Similar behaviour is displayed by adhesive tapes based on synthetic rubbers (styrene block copolymers) such as SBS/SIS. Even the hydrogenated products are limited in their temperature class.

Moreover, there are cable wrapping tapes with pressure sensitive adhesives based on UV-crosslinkable polyacrylic esters. These do meet the high temperature classes, but display a propensity towards flagging.

The realisation of adhesive tapes (for cable bandaging) that are easy to unwind while at the same time retaining good technical adhesive properties poses a major challenge, since the two properties appear to be mutually exclusive—the essential criteria in the case of single-sidedly bonding cable wrapping tapes, namely adapted unwind force and sufficiently high peel adhesion, go very much against one another. While good peel adhesion values and an associated low flagging potential require good flow-on and anchoring behaviour on the part of the pressure sensitive adhesive, these criteria tend to be a hindrance to trouble-free unwind performance.

It is an object of the present invention to provide an adhesive tape which in spite of easy unwind has good flagging resistance and at the same time exhibits cable compatibility on cables with T3-PVC insulation, while allowing the particularly simple, inexpensive and rapid jacketing of elongate products such as cable looms in motor vehicles.

This object is achieved by means of an adhesive tape as recorded in the main claim. Dependent claims provide advantageous developments of the adhesive tape and methods for employing the adhesive tape.

The invention relates accordingly to an adhesive tape in particular for wrapping cables, composed of a preferably textile carrier and of a pressure sensitive adhesive, applied on at least one side of the carrier, in the form of a dried and crosslinker-free polymer dispersion, the polymer having been synthesized from:
(a) 97.0 to 98.0 wt % of n-butyl acrylate and/or 2-ethylhexyl acrylate
(b) 2.0 to 3.0 wt % of an ethylenically unsaturated monomer having an acid or acid-anhydride function.

The polymer consists preferably of 97.2 to 97.7 wt % of n-butyl acrylate and/or 2-ethylhexyl acrylate and 2.3 to 2.8 wt % of an ethylenically unsaturated monomer having an acid or acid anhydride function.

“Crosslinker-free” in the sense of this invention means that no compounds capable of crosslinking are added to the pressure sensitive adhesive.

As used here, the term “crosslinker” stands for chemical compounds which are capable of joining molecular chains to one another, and hence are able to form three-dimensionally crosslinked structures from the two-dimensional structures, with formation of intermolecular bridges.

Crosslinkers are those compounds—especially difunctional or polyfunctional and mostly of low molecular mass—that under the selected crosslinking conditions are able to react with suitable—especially functional—groups of the polymers to be crosslinked, and therefore to link to one another (“bridge” two or more polymers or polymer sites and thus create a network composed of the polymer or polymers to be crosslinked. This generally results in an increase in the cohesion.

Typical examples of crosslinkers are chemical compounds which within the molecule or at the two molecule ends have two or more identical or different functional groups and consequently are able to crosslink molecules of the same or else different structures with one another. Moreover, a crosslinker may react with the reactive monomer or reactive resin, as defined above, without there being any polymerization in the actual sense. The reason is that unlike the activator, as described above, a crosslinker can be incorporated into the polymer network.

Besides the acrylate polymers recited, and besides any residual monomers present, the pressure sensitive adhesive may additionally be admixed with the tackifiers and/or adjuvants that are referred to later on below, such as light stabilizers or ageing inhibitors, in the quantities likewise stated below.

In particular there are no further polymers such as elastomers present in the pressure sensitive adhesive, meaning that the polymers of the pressure sensitive adhesive consist only of the monomers (a) and (b) in the proportions indicated.

Monomer (a) is preferably formed by n-butyl acrylate.

Examples of monomers contemplated as (b) advantageously include acrylic acid, methacrylic acid, itaconic acid, maleic acid, fumaric acid and/or maleic anhydride. Preferred is (meth)acrylic acid of the Formula I,

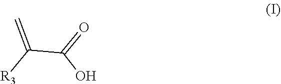

where R³=is H or CH₃, preference is given optionally to using the mixture of acrylic acid or methacrylic acid. Acrylic acid is particularly preferred.

According to one particularly preferred variant, the composition of the polymer is as follows:
(a) 97.0 to 98.0 wt %, preferably 97.2 to 97.7 wt % of n-butyl acrylate and
(b) 2.0 to 3.0 wt %, preferably 2.3 to 2.8 wt % of acrylic acid.

The polymer dispersion is prepared by the process of emulsion polymerization of the stated components. Descriptions of this process can be found for example in “Emulsion Polymerization and Emulsion Polymers” by Peter A. Lovell and Mohamed S. El-Aasser—Wiley-VCH 1997—ISBN 0-471-96746-7 or in EP 1 378 527 B1.

During the polymerization it cannot be ruled out that not all of the monomers undergo reaction to form polymers. It is obvious here that the residual monomer content is to be as small as possible.

Preference is given to providing adhesives comprising the polymer dispersion with a residual monomer content of less than or equal to 1 wt %, more particularly less than or equal to 0.5 wt % (based on the mass of the dry polymer dispersion).

The adhesive is a pressure sensitive adhesive (PSA), in other words an adhesive which even under relatively weak applied pressure allows durable bonding to virtually all substrates and which after use can be detached from the substrate again substantially without residue. A PSA has a permanently pressure-sensitive adhesive effect at room temperature, in other words possessing sufficiently low viscosity and a high tack, and so the surface of the bonding substrate in question is wetted even with low applied pressure. The bondability of the adhesive derives from its adhesive properties, and the redetachability from its cohesive properties.

In order to acquire pressure-sensitive adhesive properties, the adhesive must be above its glass transition temperature at the processing temperature, in order to have viscoelastic properties. Because cable loom wrapping takes place at normal ambient temperature (approximately between 15° C. to 25° C.), the glass transition temperature of the PSA formulation is preferably below +15° C. (determined by DSC (Differential Scanning Calorimetry) in accordance with DIN 53 765 at a heating rate of 10 K/min).

The glass transition temperature of the acrylate copolymers can be estimated, in accordance with the equation of Fox, from the glass transition temperatures of the homopolymers and from their relative proportions.

In order to obtain polymers, as for example pressure sensitive adhesives or heat-sealing compounds, having desired glass transition temperatures, the quantitative composition of the monomer mixture is advantageously selected such that an equation (E1) in analogy to the Fox equation (cf. T. G. Fox, Bull. Am. Phys. Soc. 1956, 1, 123) produces the desired T_{g} for the polymer.

$$\frac{1}{{T}_{g}} = {\sum }_{n} \frac{{w}_{n}}{{T}_{g , n}} \qquad ( E1 )$$

The possible addition of tackifiers automatically raises the glass transition temperature, by around 5 to 40 K, depending on amount added, compatibility and softening temperature.

Acrylate copolymers having a glass transition temperature of at most 0° C. are therefore preferred.

The polymers of the invention in accordance with ASTM D3330 have a peel adhesion to steel of at least 1.0 N/cm (for an adhesive coat weight of 30 g/m² on a 23 μm polyester film carrier).

A “tackifier resin” is understood, in accordance with the general understanding of the skilled person, to refer to an oligomeric or polymeric resin which raises the autoadhesion (the tack, the inherent adhesiveness) of the PSA by comparison with the PSA that is otherwise identical but contains no tackifier resin.

The use of tackifiers for boosting the peel adhesion values of PSAs is known in principle. This effect also comes about if the adhesive is admixed with up to 15 parts by weight (corresponding to <15 parts by weight), or 5 to 15 parts by weight, of tackifier (based on the mass of the dried polymer dispersion). Preference is given to adding 5 to 12, more preferably 6 to 10, parts by weight of tackifier (based on the mass of the dried polymer dispersion).

Suitability as tackifiers, also referred to as tackifier resins, is possessed in principle by all known classes of compound. Tackifiers are, for example, hydrocarbon resins (for example, polymers based on unsaturated C₅ or C₉ monomers), terpene phenolic resins, polyterpene resins based on raw materials such as, for example, α- or β-pinene, aromatic resins such as coumarone-indene resins or resins based on styrene or α-methylstyrene such as rosin and its derivatives, for example disproportionated, dimerized or esterified rosin, for example reaction products with glycol, glycerol or pentaerythritol, to name but a few. Preferred resins are those without readily oxidizable double bonds, such as terpene phenolic resins, aromatic resins and very preferably resins produced by hydrogenation, such as, for example, hydrogenated aromatic resins, hydrogenated polycyclopentadiene resins, hydrogenated rosin derivatives or hydrogenated polyterpene resins.

Preferred resins are those based on terpene phenols and rosin esters. Likewise preferred are tackifier resins having a softening point of more than 80° C. according to ASTM E28-99 (2009). Particularly preferred are resins based on terpene phenols and rosin esters having a softening point of more than 90° C. according to ASTM E28-99 (2009). The resins are usefully employed in dispersion form. In that way they can easily be mixed in finely divided form with the polymer dispersion.

Particularly preferred is the variant of the invention wherein no tackifier resins at all have been added to the PSA.

Surprisingly and unforeseeably for the skilled person, the absence of tackifier resins from the adhesive tape of the invention does not—as the skilled person would have expected—result in inadequate peel adhesion. Surprisingly, furthermore, the flagging behaviour as well is not poorer.

In particular, the PSA is not admixed with the following substances:
Hydrocarbon resins (for example polymers based on unsaturated C₅ or C₉ monomers)
Terpene phenolic resins
Polyterpene resins based on raw materials such as α- or β-pinene, for example
Aromatic resins such as coumarone-indene resins or resins based on styrene or α-methylstyrene such as rosin and its derivatives, for example disproportionated, dimerized or esterified rosin, for example reaction products with glycol, glycerol or pentaerythritol.

For further improvement in the cable compatibility, the adhesive formulation may optionally have been blended with light stabilizers or with primary and/or secondary ageing inhibitors.

Ageing inhibitors used may be products based on sterically hindered phenols, phosphites, thiosynergists, sterically hindered amines or UV absorbers.

Preference is given to using primary antioxidants such as, for example, Irganox 1010 or Irganox 254, alone or in combination with secondary antioxidants such as, for example, Irgafos TNPP or Irgafos 168.

The ageing inhibitors here may be used in any desired combination with one another, with particularly good ageing inhibition being displayed by mixtures of primary and secondary antioxidants in combination with light stabilizers such as Tinuvin 213, for example.

Ageing inhibitors in which a primary antioxidant is united with a secondary antioxidant in one molecule have proved to be especially advantageous. These ageing inhibitors comprise cresol derivatives whose aromatic ring is substituted at two arbitrary, different locations, preferably in ortho- and meta-position relative to the OH group, by thioalkyl chains, it also being possible for the sulfur atom to be joined to the aromatic ring of the cresol building block via one or more alkyl chains. The number of carbon atoms between the aromatic moiety and the sulfur atom may be between 1 and 10, preferably between 1 and 4. The number of carbon atoms in the alkyl side chain may be between 1 and 25, preferably between 6 and 16. Particularly preferred in this context are compounds of the 4,6-bis(dodecylthiomethyl)-o-cresol, 4,6-bis(undecylthiomethyl)-o-cresol, 4,6-bis(decylthiomethyl)-o-cresol 4,6-bis(nonylthiomethyl)-o-cresol or 4,6-bis(octylthiomethyl)-o-cresol type. Ageing inhibitors of these kinds are available for example from the company Ciba Geigy under the name Irganox 1726 or Irganox 1520.

The amount of the ageing inhibitor or ageing inhibitor package added ought to be situated within a range between 0.1 and 10 parts by weight, based on the mass of the dried polymer dispersion, preferably in a range between 0.2 and 5 parts by weight, based on the mass of the dried polymer dispersion, very preferably in a range between 0.5 and 3 parts by weight, based on the mass of the dried polymer dispersion.

Preference is given to a presentation form in the form of a dispersion for particularly simple miscibility with the adhesive dispersion. Alternatively it is also possible for liquid ageing inhibitors to be incorporated directly into the dispersion, in which case the step of incorporation ought to be followed by a standing time of a number of hours, to allow the homogeneous distribution of the ageing inhibitor in the dispersion or its acceptance into the dispersion particles. A further alternative is the addition of an organic solution of the ageing inhibitors to the dispersion.

Suitable concentrations lie in the range from 0.1 up to 8, preferably 0.1 to 5 parts by weight, based on the mass of the dried polymer dispersion.

For improving the processing properties, the adhesive formulation may further have been blended with customary process auxiliaries such as rheological additives (thickeners), defoamers, deaerating agents, wetting agents or flow control agents. Suitable concentrations are in the range from 0.1 up to 5 parts by weight, based on the mass of the dried polymer dispersion.

A fundamental distinction is made here between organic and inorganic rheological additives.

The organic thickeners divide in turn into two essential modes of action: (i) the thickening of the aqueous phase, i.e. non-associating, and (ii) association between thickener molecule and particles, in part with incorporation of the stabilizers (emulsifiers). Representatives of the first (i) compound group are water-soluble polyacrylic acids and polycoacrylic acids, which in the basic medium form polyelectrolytes of high hydrodynamic volume. The skilled person also refers to these for short as ASE (alkali swellable emulsion). They are distinguished by high resting shear viscosities and strong shear thinning. Another class of compound are the modified polysaccharides, especially cellulose ethers such as carboxymethylcellulose, 2-hydroxyethylcellulose, carboxymethyl-2-hydroxyethylcellulose, methylcellulose, 2-hydroxyethylmethylcellulose, 2-hydroxyethylethylcellulose, 2-hydroxypropylcellulose, 2-hydroxypropylmethylcellulose, 2-hydroxybutylmethylcellulose. Additionally included in this class of compound are less widespread polysaccharides such as starch derivatives and specific polyethers.

The active group of the (ii) associative thickeners are, in principle, block copolymers having a water-soluble middle block and hydrophobic end blocks, the end blocks interacting with the particles or with themselves and so forming a three-dimensional network with incorporation of the particles. Typical representatives are familiar to the skilled person as HASE (hydrophobically modified alkali swellable emulsion), HEUR (hydrophobically modified ethylene oxide urethane) or HMHEC (hydrophobically modified hydroxyethyl cellulose). In the case of the HASE thickeners, the middle block is an ASE, and the end blocks are usually long, hydrophobic alkyl chains coupled on via polyethylene oxide bridges. In the case of the HEUR, the water-soluble middle block is a polyurethane, and in the HMHEC it is a 2-hydroxyethylcellulose. The non-ionic HEUR and HMHEC, in particular, are largely insensitive to pH.

Depending on structure, the associative thickeners produce more or less a Newtonian (shear rate-independent) or pseudoplastic (shear-liquefying) flow behaviour. Occasionally they also exhibit a thixotropic character, meaning that the viscosity is subject not only to dependency on shearing force but also to dependency on time.

The inorganic thickeners are usually phyllosilicates of natural or synthetic origin, examples being hectorites and smectites. In contact with water, the individual layers part from one another. At rest, as a result of different charges on surfaces and edges of the platelets, they form a space-filling house-of-cards structure, resulting in high resting shear viscosities through to yield points. On shearing, the house-of-cards structure lapses and a marked drop in the shear viscosity is observed. Depending on charge, concentration and geometrical dimensions of the platelets, the development of structure may take some time, and so with inorganic thickeners of this kind it is also possible to obtain thixotropy.

The thickeners can in some cases be stirred directly into the adhesive dispersion, or in some cases are predispersed or prediluted advantageously in water beforehand.

Suppliers of thickeners are, for example, OMG Borchers, Omya, Byk Chemie, Dow Chemical Company, Evonik, Rockwood, or Münzing Chemie.

Fillers (reinforcing or non-reinforcing) such as silicon dioxides (spherical, acicular, platelet-shaped or irregular like the fumed silicas), glass in the form of solid or hollow beads, microballoons, calcium carbonates, zinc oxides, titanium dioxides, aluminium oxides or aluminium oxide hydroxides may serve for fine-tuning the processing properties and also the technical adhesive properties. Suitable concentrations are in the range from 0.1 up to 20 parts by weight, based on the mass of the dried polymer dispersion.

In one preferred embodiment the adhesive formulation of the invention has a peel adhesion to steel in accordance with ASTM D3330 of at least 2.0 N/cm (for an adhesive coat weight of about 100 g/m² on a woven polyester carrier, in accordance with the example).

Suitable carriers include in principle all carrier materials, preferably textile carriers and more preferably woven fabrics, more particularly woven polyester fabrics.

As carrier material for the adhesive tape it is possible to use all known textile carriers such as knitted fabrics, scrims, tapes, braids, tufted textiles, felts, woven fabrics (encompassing plain weave, twill and satin weave), knitted fabrics (encompassing warp knits and other knits) or nonwoven webs, the term “nonwoven web” comprehending at least sheetlike textile structures in accordance with EN 29092 (1988) and also stitchbonded webs and similar systems.

It is likewise possible to use woven and knitted spacer fabrics with lamination. Spacer fabrics of these kinds are disclosed in EP 0 071 212 B1. Spacer fabrics are mat-like layer structures comprising a cover layer of a fibre or filament web, an underlayer and individual retaining fibres or bundles of such fibres between these layers, these fibres being distributed over the area of the layer structure, being needled through the particle layer and joining the cover layer and the underlayer to one another. As an additional although not mandatory feature, the retaining fibres in accordance with EP 0 071 212 B1 contain particles of inert minerals, such as sand, gravel or the like, for example.

The retaining fibres needled through the particle layer hold the cover layer and the underlayer at a distance from one another and are joined to the cover layer and the underlayer.

Nonwovens contemplated include, in particular, consolidated staple fibre webs, but also filament webs, meltblown webs and spunbonded webs, which generally require additional consolidation. Possible consolidation methods known for webs include mechanical, thermal and chemical consolidation. If with mechanical consolidations the fibres are held together purely mechanically usually by entanglement of the individual fibres, by the interlooping of fibre bundles or by the stitching-in of additional threads, it is possible by thermal and by chemical techniques to obtain adhesive (with binder) or cohesive (binderless) fibre-fibre bonds. Given appropriate formulation and an appropriate process regime, these bonds may be restricted exclusively, or at least predominantly, to fibre nodal points, so that a stable, three-dimensional network is formed while nevertheless retaining the relatively loose, open structure in the web.

Webs which have proved to be particularly advantageous are those consolidated in particular by overstitching with separate threads or by interlooping.

Consolidated webs of this kind are produced for example on stitchbonding machines of the “Malimo” type from the company Karl Mayer, formerly Malimo, and can be obtained from companies including Techtex GmbH. A Malifleece is characterized in that a cross-laid web is consolidated by the formation of loops from fibres of the web.

The carrier used may also be a web of the Kunit or Multiknit type. A Kunit web is characterized in that it originates from the processing of a longitudinally oriented fibre web to form a sheetlike structure which has loops on one side and has loop feet or pile fibre folds on the other side, but possesses neither threads nor prefabricated sheetlike structures. A web of this kind as well has been produced for a relatively long time, for example on stitchbonding machines of the “Malimo” type from the company Karl Mayer. A further characterizing feature of this web is that, as a longitudinal-fibre web, it is able to absorb high tensile forces in the longitudinal direction. The characteristic feature of a Multiknit web relative to the Kunit web is that the web is consolidated on both the top and bottom sides by virtue of the double-sided needle punching. The starting product used for a Multiknit is generally one or two single-sidedly interlooped pile fibre nonwovens produced by the Kunit process. In the end product, both top sides of the nonwovens are shaped by means of interlooped fibres to form a closed surface, and are joined to one another by fibres which stand almost perpendicularly. An additional possibility is to introduce further needlable sheetlike structures and/or scatterable media.

Finally, stitchbonded webs as an intermediate are also suitable for forming a liner of the invention and an adhesive tape of the invention. A stitchbonded web is formed from a nonwoven material having a large number of stitches extending parallel to one another. These stitches are brought about by the stitching-in or stitchbonding of continuous textile threads. For this type of web, stitchbonding machines of the “Malimo” type from the company Karl Mayer are known.

Also particularly suitable are needlefelt webs. In a needlefelt web, a tuft of fibres is made into a sheetlike structure by means of needles provided with barbs. By alternate introduction and withdrawal of the needles, the material is consolidated on a needle bar, with the individual fibres interlooping to form a firm sheetlike structure. The number and configuration of the needling points (needle shape, penetration depth, double-sided needling) determine the thickness and strength of the fibre structures, which are in general lightweight, air-permeable and elastic.

Also particularly advantageous is a staple fibre web which is mechanically preconsolidated in the first step or is a wet-laid web laid hydrodynamically, in which between 2% and 50% by weight of the web fibres are fusible fibres, more particularly between 5% and 40% by weight of the web fibres.

A web of this kind is characterized in that the fibres are laid wet or, for example, a staple fibre web is preconsolidated by the formation of loops from fibres of the web by needling, stitching or air-jet and/or water-jet treatment.

In a second step, thermofixing takes place, with the strength of the web being increased again by the melting, or partial melting, of the fusible fibres.

For the utilization of nonwovens in accordance with the invention, the adhesive consolidation of mechanically preconsolidated or wet-laid webs is of particular interest, it being possible for said consolidation to take place by way of the addition of binder in solid, liquid, foamed or paste-like form. A great diversity of theoretical presentation forms is possible: for example, solid binders as powders for trickling in; as a sheet or as a mesh; or in the form of binding fibres. Liquid binders may be applied as solutions in water or organic solvents, or as a dispersion. For adhesive consolidation, binding dispersions are predominantly selected: thermosets in the form of phenolic or melamine resin dispersions, elastomers as dispersions of natural or synthetic rubbers or, usually, dispersions of thermoplastics such as acrylates, vinyl acetates, polyurethanes, styrene-butadiene systems, PVC, and the like, and also copolymers thereof. Normally the dispersions are anionically or nonionically stabilized, although in certain cases cationic dispersions may also be of advantage.

The binder may be applied in a manner which is in accordance with the prior art and for which it is possible to consult, for example, standard works of coating or of nonwoven technology such as “Vliesstoffe” (Georg Thieme Verlag, Stuttgart, 1982) or “Textiltechnik-Vliesstofferzeugung” (Arbeitgeberkreis Gesamttextil, Eschborn, 1996).

For mechanically preconsolidated webs which already possess sufficient composite strength, the single-sided spray application of a binder is appropriate for producing specific changes in the surface properties.

Such a procedure not only is sparing in its use of binder but also greatly reduces the energy requirement for drying. Since no squeeze rolls are required and the dispersions remain predominantly in the upper region of the nonwoven, unwanted hardening and stiffening of the web can be largely prevented.

For sufficient adhesive consolidation of the web carrier, the addition of binder in the order of magnitude of 1% to 50%, more particularly 3% to 20%, based on the weight of the fibre web, is generally required.

The binder may be added as early as during the manufacture of the web, in the course of mechanical preconsolidation, or else in a separate process step, which may be carried out in-line or off-line. Following the addition of binder, it is necessary temporarily to generate a condition for the binder in which the binder becomes adhesive and adhesively connects the fibres—this may be achieved during the drying, for example, of dispersions, or else by means of heating, with further possibilities for variation existing by way of areal or partial application of pressure. The binder may be activated in known drying tunnels, given an appropriate selection of binder, or else by means of infra-red radiation, UV radiation, ultra-sound, high-frequency radiation or the like. For the subsequent end use it is sensible, though not absolutely necessary, for the binder to have lost its tack following the end of the web production process. It is advantageous that, as a result of thermal treatment, volatile components such as fibre assistants are removed, giving a web having favourable fogging values, so that when a low-fogging adhesive is used, it is possible to produce an adhesive tape having particularly favourable fogging values; accordingly, the liner as well has a very low fogging value.

By fogging (see DIN 75201 A) is meant the effect where, under unfavourable conditions, compounds of low molecular mass may outgas from the adhesive tapes and condense on cold parts. As a result of this it is possible, for example, for the view through the windscreen to be adversely affected.

A further special form of adhesive consolidation involves activating the binder by partial dissolution or partial swelling. In this case it is also possible in principle for the fibres themselves, or admixed speciality fibres, to take over the function of the binder. Since, however, such solvents are objectionable on environmental grounds, and/or are problematic in their handling, for the majority of polymeric fibres, this process is not often employed.

Advantageously and at least in regions, the carrier may have a single-sidedly or double-sidedly polished surface, preferably in each case a surface polished over the whole area. The polished surface may be chintzed, as elucidated in detail in EP 1 448 744 A1, for example.

Furthermore, the carrier may be compacted by calendering on a roll mill. The two rolls preferably run in opposite directions and at the same peripheral speed, causing the carrier to be pressed and compacted.

If there is a difference in the peripheral speed of the rolls, then the carrier is additionally polished.

The carrier is preferably a woven fabric, more preferably a woven polyester fabric. Particular preference is given to fabrics having the following construction:
the thread count in the warp is 10 to 60/cm
the thread count in the weft is 10 to 40/cm
the warp threads possess a yarn weight of between 40 and 400 dtex, more particularly between 44 and 330 dtex, very preferably of 167 dtex
the weft threads possess a yarn weight of between 40 and 660 dtex, more preferably between 44 and 400 dtex, very preferably of 167 dtex.

According to a further advantageous embodiment of the invention, the thread count in the warp is 40 to 50/cm, preferably 44/cm.

According to a further advantageous embodiment of the invention, the thread count in the weft is 18 to 22/cm, preferably 20/cm.

According to a further advantageous embodiment of the invention, the woven fabric is a woven polyester fabric. Further possibilities are woven polyamide fabrics, woven viscose fabric and/or a woven blend fabric comprising the stated materials.

With further preference the thickness of the woven fabric is at most 300 μm, more preferably 170 to 230 μm, very preferably 190 to 210 μm.

According to another advantageous embodiment of the invention, the carrier has a basis weight of up to 200 g/m², preferably 100 to 150 g/m².

Starting materials for the carrier material for the adhesive tape are more particularly (manmade) fibres (staple fibre or continuous filament) made from synthetic polymers, also called synthetic fibres, made from polyester, polyamide, polyimide, aramid, polyolefin, polyacrylonitrile or glass, (manmade) fibres made from natural polymers such as cellulosic fibres (viscose, Modal, Lyocell, Cupro, acetate, triacetate, Cellulon), such as rubber fibres, such as plant protein fibres and/or such as animal protein fibres and/or natural fibres made of cotton, sisal, flax, silk, hemp, linen, coconut or wool. The present invention, however, is not confined to the materials stated; it is instead possible, as evident to the skilled person without having to take an inventive step, to use a multiplicity of further fibres in order to produce the carrier.

Likewise suitable, furthermore, are yarns fabricated from the fibres specified.

In the case of woven fabrics or scrims, individual threads may be produced from a blend yarn, and thus may have synthetic and natural constituents. Generally speaking, however, the warp threads and the weft threads are each formed of a single kind.

The warp threads and/or the weft threads here may in each case be composed only of synthetic threads or only of threads made from natural raw materials—in other words, of a single kind.

The yarns or threads of the woven fabrics may be in the form of filaments. For the purposes of this invention, a filament refers to a bundle of parallel individual linear fibres/filaments, often also referred to in the literature as a multifilament. This fibre bundle may optionally be given inherent strengthening by torsion, and is then referred to as spun or folded filaments. Alternatively, the fibre bundle can be given inherent strengthening by entangling using compressed air or waterjets. In the text below, for all of these embodiments, only the term “filament” will be used, in a generalizing way.

The filament may be textured or smoothed and may have point strengthening or no strengthening.

Also suitable for the adhesive tape is a carrier material which consists of paper, of a laminate, of a film (for example PP, PE, PET, PA, PU), of foam or of a foamed film.

These non-textile sheetlike materials are especially appropriate when specific requirements necessitate such a modification of the invention. Films are generally thinner in comparison to textiles, for example, and, as a result of the imperforate layer, offer additional protection against penetration by chemicals and service fluids such as oil, petrol, antifreeze and the like into the actual cable area, and can be substantially adapted to requirements by an appropriate selection of the material from which they are constructed. With polyurethanes or polyolefin copolymers, for example, flexible and elastic jackets can be produced; with polyester and polyamides, good abrasion resistance and temperature stability are achieved.

Foams or foamed films, on the other hand, possess the qualities of more substantial space filling and of good soundproofing—where a length of cable is laid, for example, in a duct-like or tunnel-like area in the vehicle, a jacketing tape of appropriate thickness and soundproofing can prevent disruptive flapping and vibration from the outset.

Preference is given to a laminate of the textile carrier and of polymeric layer or film applied at least to one side of the textile carrier. It is additionally possible for films and/or polymeric layers to be applied on the topside and the bottom side of the textile carrier.

Application may take place by lamination or by extrusion.

In a preferred variant, a nonwoven web is provided on its bottom side with a film, which on the other side is furnished with a pressure sensitive adhesive.

Suitable material for films or polymeric material comprises films such as, for example, PP, PE, polyester, PA, PU or PVC. The films themselves may consist in turn of a plurality of individual plies, as for example of plies which are coextruded to form film.

Preference is given to polyolefins, but copolymers of ethylene and polar monomers such as styrene, vinyl acetate, methyl methacrylate, butyl acrylate or acrylic acid are also included. It may be a homopolymer such as HDPE, LDPE, MDPE or a copolymer of ethylene with a further olefin such as propene, butene, hexene or octene (for example LLDPE, VLDPE). Also suitable are polypropylenes (for example polypropylene homopolymers, random polypropylene copolymers or polypropylene block copolymers).

The film preferably has a thickness of 12 μm to 100 μm, more preferably 28 to 50 μm, more particularly 35 μm.

The film may be coloured and/or transparent.

The adhesive tape may ultimately have a liner material, with which the one or two layers of adhesive are lined before use. Suitable liner materials also include all of the materials set out comprehensively above.

It is preferred to use a non-linting material such as a polymeric film or a well-sized, long-fibre paper.

If the adhesive tape described is to be of low flammability, this quality can be achieved by adding flame retardants to the carrier and/or to the adhesive. These retardants may be organobromine compounds, if required with synergists such as antimony trioxide, although, with regard to the absence of halogen from the adhesive tape, preference will be given to using red phosphorus, organophosphorus compounds, mineral compounds or intumescent compounds such as ammonium polyphosphate, alone or in conjunction with synergists.

The adhesive coat weight, based on the adhesive tape area, is preferably between 40 and 160 g/m², more preferably between 60 and 130 g/m², with further preference between 80 and 100 g/m².

The general expression “adhesive tape” in the context of this invention encompasses all sheetlike structures such as two-dimensionally extended sheets or sheet sections, tapes with extended length and limited width, tape sections and the like, and also, lastly, diecuts or labels.

The adhesive tape therefore has a longitudinal extent and a latitudinal extent. The adhesive tape also has a thickness, extending perpendicularly to both extents, with the latitudinal extent and longitudinal extent being greater by a multiple than the thickness. The thickness is very largely the same, preferably exactly the same, over the entire superficial extent of the adhesive tape defined by length and width.

The adhesive tape is present in particular in the form of a sheet web. A sheet web is an object whose length is greater by a multiple than the width, with the width being approximately and preferably exactly the same along the entire length.

The adhesive tape may be produced in the form of a roll, in other words rolled up onto itself in the form of an Archimedean spiral.

Applied to the reverse of the adhesive tape may be a reverse-face varnish, in order to exert a favourable influence on the unwind properties of the adhesive tape wound into the Archimedean spiral. This reverse-face varnish may for this purpose be furnished with silicone compounds or fluorosilicone compounds and also with polyvinylstearylcarbamate, polyethyleneiminestearylcarbamide or organofluorine compounds as adhesive substances.

The adhesive may be applied in the longitudinal direction of the adhesive tape, in the form of a stripe, the width of the stripe being lower than that of the carrier of the adhesive tape.

Depending on the particular utility, there may also be a plurality of parallel stripes of the adhesive coated on the carrier material.

The position of the stripe on the carrier is freely selectable, with preference being given to an arrangement directly at one of the edges of the carrier.

The adhesive is preferably applied over the full area to the carrier.

Provided on the adhesive coating of the carrier there may be at least one stripe of a covering, extending in the longitudinal direction of the adhesive tape and covering between 20% and 90% of the adhesive coating.

The stripe preferably covers in total between 50% and 80% of the adhesive coating. The degree of coverage is selected according to the application and to the diameter of the cable loom.

The percentage figures indicated relate to the width of the stripes of the covering in relation to the width of the carrier.

In accordance with one preferred embodiment of the invention there is precisely one stripe of the covering present on the adhesive coating.

The position of the stripe on the adhesive coating is freely selectable, with preference being given to an arrangement directly at one of the longitudinal edges of the carrier. In this way an adhesive stripe is produced which extends in the longitudinal direction of the adhesive tape and finishes at the other longitudinal edge of the carrier.

Where the adhesive tape is used for jacketing a cable harness, by the adhesive tape being passed in a helicoidal movement around the cable harness, the wrapping of the cable harness may be accomplished by bonding the adhesive of the adhesive tape only to the adhesive tape itself, with the substrate not coming into contact with any adhesive.

The cable harness jacketed in this way has a very high flexibility, as a result of the absence of fixing of the cable by any adhesive. Consequently the flexibility of said cable harness on installation—particularly in narrow passages or sharp bends—is significantly increased.

If a certain degree of fixing of the adhesive tape on the substrate is desired, the jacketing may be accomplished by bonding part of the adhesive stripe to the adhesive tape itself and another part to the substrate.

In accordance with another advantageous embodiment, the stripe is applied centrally on the adhesive coating, thereby producing two adhesive stripes extending on the longitudinal edges of the carrier in the longitudinal direction of the adhesive tape.

For the secure and economic application of the adhesive tape in said helicoidal movement around the cable harness, and to counter the slipping of the resultant protective wrapping, the two adhesive stripes each present on the longitudinal edges of the adhesive tape are advantageous, especially if one stripe, which is usually narrower than the second stripe, serves as a fixing aid and the second, broader stripe serves as a fastener. In this way, the adhesive tape is bonded to the cable in such a way that the cable loom is secured against slipping but is nevertheless of flexible design.

In addition there are embodiments in which more than one stripe of the covering is applied to the adhesive coating. Where reference is made only to one stripe, the skilled person reads this, conceptually, as accommodating the possibility that there may well be two or more stripes covering the adhesive coating at the same time.

The procedure for producing the adhesive tape of the invention involves nothing more than the coating of the carrier directly with the dispersion in one or more operations carried out in succession. In the case of textile carriers, the untreated textile can be coated directly or by a transfer process. Alternatively the textile may be pretreated with a coating (using any desired film-forming substance from solution, dispersion, melt and/or radiation-curing), before then being provided, in a downstream work-step, directly or by a transfer process, with the PSA.

Application assemblies used are the customary ones: wire doctor, coating bar, roll application, nozzle coating, twin-chamber doctor blade, multiple cascade die.

On the basis of the positive properties outlined, the adhesive tape can be used outstandingly for insulating and wrapping wires or cables.

Furthermore, it is advantageously suitable for the jacketing of elongate material such as, more particularly, cable looms in motor vehicles, with the adhesive tape being passed in a helical line around the elongate material, or the elongate material being wrapped in axial direction by the tape.

Lastly, the concept of the invention also embraces an elongate material jacketed with an adhesive tape of the invention. The elongate material is preferably a cable loom.

On account of the outstanding suitability of the adhesive tape, it can be used in a jacket that consists of a covering, where, at least in one edge region of the covering, the self-adhesive tape is present, and is bonded on the covering in such a way that the adhesive tape extends over one of the longitudinal edges of the covering, and preferably in an edge region which is narrow by comparison with the width of the covering.

One such product and also optimized embodiments thereof are disclosed in EP 1 312 097 A1. EP 1 300 452 A2, DE 102 29 527 A1 and WO 2006 108 871 A1 show ongoing developments for which the adhesive tape of the invention is likewise very suitable. The adhesive tape of the invention may also find use in a method of the kind disclosed by EP 1 367 608 A2.

Finally, EP 1 315 781 A1 and DE 103 29 994 A1 describe embodiments of adhesive tapes of a kind also possible for the adhesive tape of the invention.

With further preference the adhesive tape, in bonding to cables with PVC jacketing and to cables with polyolefin jacketing, does not destroy these systems when an assembly composed of cables and adhesive tape is, in accordance with LV 312, stored at temperatures above 100° C. and for up to 3000 hours and then the cables are bent around a mandrel.

The adhesive tape of the invention is outstandingly suitable for the wrapping of cables, can be easily unwound for simple processing, exhibits little or no flagging, and exhibits no cable embrittlement even in the high temperature classes T3 and T4 over 3000 hours.

### BRIEF DESCRIPTION OF THE DRAWINGS

The purpose of the text below is to illustrate the adhesive tape in more detail using a number of figures, without wishing thereby to bring about a restriction of whatever kind.

FIG. 1 shows the adhesive tape in a lateral section,

FIG. 2 shows a detail of a cable harness which is composed of a bundle of individual cables and is jacketed with the adhesive tape of the invention,

FIG. 3 shows an advantageous application of the adhesive tape, and

FIG. 4 shows measurement of flags with a ruler after three days, ten days and 30 days under standard conditions.

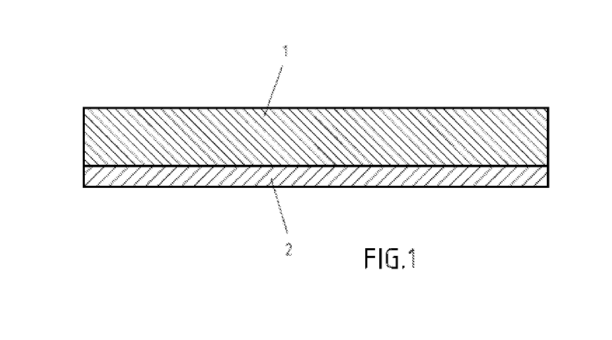

Shown in FIG. 1, in a section in the cross direction (transverse section), is the adhesive tape, consisting of a woven fabric carrier 1, on one side of which a layer of a self-adhesive coating 2, based on acrylic dispersion is applied.

The adhesive has been absorbed to an extent of 20% into the carrier, thus producing optimum anchoring and at the same time improving the manual tearability of the carrier.

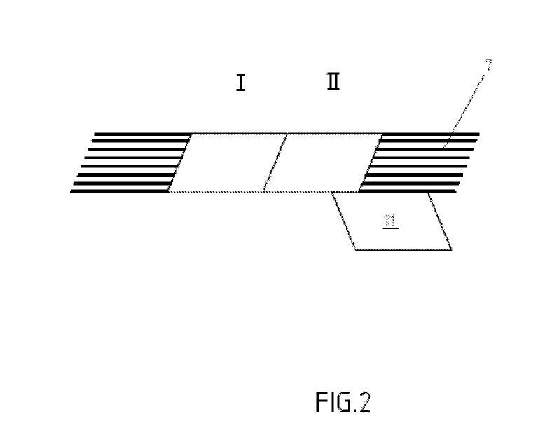

FIG. 2 shows a detail of a cable harness which is composed of a bundle of individual cables 7 and is jacketed with the adhesive tape 11 of the invention. The adhesive tape is passed in a helicoidal movement around the cable harness.

The detail of the cable harness shown has two turns I and II of the adhesive tape. Further turns would extend towards the left, but are not shown here.

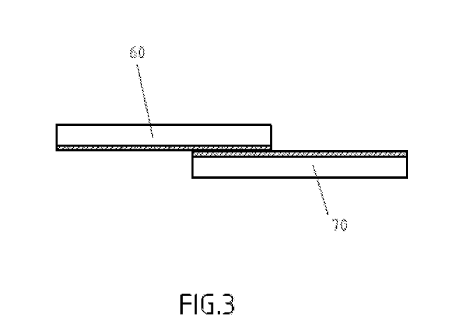

In a further embodiment for jacketing, two tapes 60, 70 of the invention, furnished with an adhesive, are laminated with their adhesives at an offset (preferably by 50% in each case) to one another, producing a product as shown in FIG. 3.

### EXAMPLES

### Outline of the Examples

The adhesive tape of the invention is described below in a preferred embodiment by means of an example, without wishing thereby to subject the invention to any restriction whatsoever.

In addition, comparative examples are given, which show unsuitable adhesive tapes.

To illustrate the invention, example adhesive tapes were produced according to the following scheme:

The PSA dispersions were subsequently adjusted, by stirred incorporation of a polyurethane associative thickener (Borchigel 0625, OMG Borchers), to a viscosity of approximately 1000 Pa*s at a shear rate of 0.01 s⁻¹ (measured using cone/plate geometry in rotation mode with a DSR 200 N rheometer from Rheometric Scientific).

Using a film-drawing apparatus, a woven polyester fabric (linear fibre density 167 dtex, thread count warp 43 1/cm, thread count weft 25 1/cm) was coated with the thickened example PSA dispersion in such a way as to result, after drying in a forced-air oven at 85° C. for 5 minutes, in an adhesive coat weight of 90 g/m².

### Assessment Criteria

The criteria for an application-compatible adhesive tape for the wrapping of cables are
unwind force from rolls after storage at 40° C. for 4 weeks
flagging resistance as per the SWAT test
cable compatibility according to LV 312 in respect of embrittlement and discoloration.

### Procedure of the Tests

Unless expressly stated otherwise, the measurements are carried out under test conditions of 23±1° C. and 50±5% relative humidity.

### Measurement of Unwind Force to LV312

Here, a value in the range from 3 to 9 N/cm at a take-off speed of 30 m/min is considered to be compatible with the application. Values from 3 to 6 N/cm are scored with a “2”. Values from 6 to 9 N/cm receive a score of “1”; values outside these ranges receive a score of 0.

### Measurement of Flagging Resistance by the SWAT Method

The SWAT test is utilised in order to investigate the flagging behaviour of adhesive tapes after they have been wound spirally around the cable.

The test is carried out under standard conditions (23±1° C. and 50±5% relative humidity) and at 40° C. The elevated temperature simulates the more difficult requirements during transport.

The test uses an adhesive tape 19 mm wide. It is wound manually around a cable sheathed with ETFE (ethylene-tetrafluoroethylene) and having a diameter of 1 mm, four times)(1440°) without additional pressure. Scissors are used to cut the adhesive tape.

A flag on average 5 mm long is assumed to remain unless the end of the adhesive tape is pressed down.

A total of seven wraps are produced around the cable.

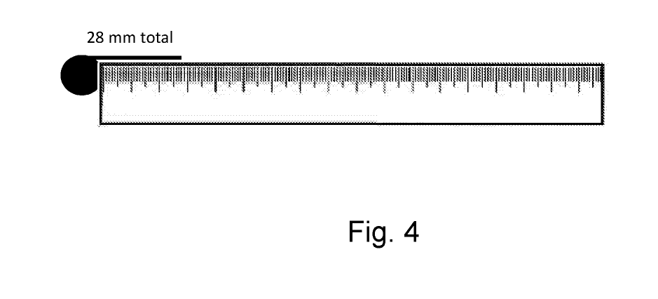

The flags are measured with a ruler after three days, ten days and 30 days under standard conditions. This is shown by FIG. 4. The absolute flagging value is computed by subtracting 5 mm from the flag length actually measured.

In FIG. 4, therefore, the flagging value is 23 mm (28 mm-5 mm).

The flagging value reported as the result is the result of the mean flagging values of the seven wraps. The test at 40° C. is carried out analogously in customary drying cabinets.

The adhesive tape of the invention is evaluated below at 40° C. in a drying cabinet by the SWAT method reported.

Here, a value of ≤10 mm is deemed to be the lower limit of resistance to flagging.

Means <5 receive a score of 2, means from 5 to 10 receive a score of 1, and means >10 receive a score of 0.

### Measurement of Cable Compatibility for Cables Having T3-PVC Insulation, Based on LV 312

cables with T3-PVC insulation are not tested in LV 312. The measurement is carried out in analogy to the measurement method specified in LV 312. The measurements are made in each case at 125° C. (T3).

### Embrittlement

If there is no embrittlement after 3000 h at 150° C. on bending around a mandrel with a diameter of 2 mm, cable compatibility is considered to exist, and is given a score of “2”. If the sample undergoes embrittlement, the specimen receives a score of “0”.

### Discoloration

The absence of discolorations, or the incidence of marginal discolorations, after 3000 h at 150° C. is considered to denote high cable compatibility and is given a score of 2. Clearly visible discolorations which are nevertheless not too dark may possibly be classed as sufficiently compatible and receive a score of “1”. Black or dark brown discolorations are considered not to be cable compatible, and receive a score of “0”.

### Measurement of Peel Adhesion

For measuring the peel adhesion of the pure dispersions, coated-out samples of the adhesives were prepared first of all. For this purpose, the dispersions were applied to a PET film (polyethylene terephthalate) with a thickness of 23 μm, and were drawn down using a film-drawing apparatus in such a way as to result, after drying for 5 minutes at 105° C. in a forced-air drying cabinet, in an adhesive coat weight of 30 g/m².

Using a cutter knife, strips 20 mm wide and 25 cm long were cut from this sheet. For measuring the peel adhesion of the formulations with resin, coated-out samples were drawn down as described above onto woven polyester fabrics, and likewise cut using a cutter knife into strips 20 mm wide and 25 cm long.

The peel adhesion to steel was measured in accordance with ASTM D3330.

### Measurement of Glass Transition Temperatures

The glass transition temperatures were determined on the DSC 204 F1 “Phönix” Dynamic Differential Scanning Calorimeter from Netzsch, Germany, in 25 μl aluminium crucibles with a perforated lid, under a nitrogen atmosphere (20 ml/min gas flow rate). The initial sample mass was 8±1 mg. The samples were subjected to measurement twice from −140° C. to 200° C., with a heating rate of 10 K/min. The subject analysis was the 2nd heating curve.

The method is based on DIN 53 765.

### Dynamic Viscosity Measurement

The viscosity measurement is carried out with a DSR 200 N rheometer from Rheometric Scientific at room temperature and in rotation mode at a shear rate of 0.01 s⁻¹ using a cone-plate system having a diameter of 50 mm.

### Composition of Example Polymer Dispersions

To illustrate the concept of the invention, polymer dispersions having the following comonomer composition were trialled:

| | Polymer | | | | |
|---|---|---|---|---|---|
| Monomer | 1 | Polymer 2 | Polymer 3 | Polymer 4 | Polymer 5 |
| 2-Ethylhexyl | 93 | 92 | | | |
| acrylate | | | | | |
| n-Butyle | — | — | 99 | 96 | 97.5 |
| acrylat | | | | | |
| Acrylic acid | 4 | 2 | 1 | 4 | 2.5 |
| Acrylonitrile | 3 | — | — | — | — |
| Methyl | — | 6 | — | — | — |
| methacrylate | | | | | |
| B1 | 100 | — | — | — | — |
| (Comparative | parts by | | | | |
| Example 1) | weight | | | | |
| B2 | — | 100 parts | — | — | — |
| (Comparative | | by weight | | | |
| Example 2) | | | | | |
| B3 | — | — | 100 parts | e | — |
| (Comparative | | | by weight | | |
| Example 3) | | | | | |
| B4 | — | — | | 100 parts | |
| (Comparative | | | | by weight | |
| Example 4) | | | | | |
| B5 | — | — | | | 100 parts |
| (Inventive | | | | | by weight |
| Example 5) | | | | | |

The test results of Examples B1 to B5 are set out below:

| | (Comparative or Inventive) | | | | |
|---|---|---|---|---|---|
| | Examples | | | | |
| | B1 | B2 | B3 | B4 | B5 |
| Unwind force | 2 | 2 | 2 | 1 | 2 |
| Flagging resistance | 0 | 0 | 2 | 2 | 2 |
| Cable compatibility: embrittlement | 1 | 1 | 1 | 1 | 2 |
| Cable compatibility: discoloration | 0 | 0 | 0 | 0 | 1 |

All four test criteria are vital for an application-compatible adhesive tape for cable jacketing. Example 5 shows an adhesive tape which conforms to the concept of the invention; the comparison examples, in contrast, are unsuitable.

Relative to Examples 1 and 2, and especially relative to Examples 3 and 4, it is evident that the compatibility on T3-PVC insulations, in terms both of embrittlement and of discoloration, can surprisingly be boosted significantly.

1. Adhesive tape for wrapping cables, consisting of an optionally textile carrier and of a pressure sensitive adhesive, applied on at least one side of the carrier, in the form of a dried and crosslinker-free polymer dispersion, the polymer having been synthesized from:
(a) 97.0 to 98.0 wt % of n-butyl acrylate and/or 2-ethylhexyl acrylate, and
(b) 2.0 to 3.0 wt % of an ethylenically unsaturated monomer having an acid or acid-anhydride function.

2. Adhesive tape according to claim 1,
wherein
the polymer has been synthesized from:
(a) 97.2 to 97.7 wt % of n-butyl acrylate and/or 2-ethylhexyl acrylate
(b) 2.3 to 2.8 wt % of an ethylenically unsaturated monomer having an acid or acid-anhydride function.

3. Adhesive tape according to claim 1,
wherein
n-butyl acrylate forms monomer (a).

4. Adhesive tape according to claim 1,
wherein
acrylic acid, methacrylic acid, itaconic acid, maleic acid, fumaric acid and/or maleic anhydride form the monomer (b).

5. Adhesive tape according to claim 1,
wherein
the polymer has the following composition:
(a) 97.2 to 97.7 wt % of n-butyl acrylate
(b) 2.3 to 2.8 wt % of acrylic acid.

6. Adhesive tape according to claim 1,
wherein
the adhesive is admixed with up to 15 parts by weight, or 5 to 15 parts by weight, of tackifier (based on the mass of the dried polymer dispersion).

7. Adhesive tape according to claim 1,
wherein
no tackifying resins at all are added to the pressure sensitive adhesive.

8. Adhesive tape according to claim 1,
wherein
the glass transition temperature of the pressure sensitive adhesive is below +15° C. (determined by DSC (Differential Scanning Calorimetry) in accordance with DIN 53 765 at a heating rate of 10 K/min).

9. Adhesive tape according to claim 1,
wherein
the pressure sensitive adhesive has a peel adhesion on steel of at least 2.0 N/cm according to ASTM D3330 (at a weight per unit area of the adhesive of 100 g/m² on woven polyester fabric as carrier).

10. Adhesive tape according to claim 1,
wherein
the carrier is a nonwoven material or a woven fabric, optionally a woven polyester fabric.

11. Adhesive tape according to claim 1,
wherein
the carrier is a woven polyester fabric having a construction as follows:
the thread count in the warp is 10 to 60/cm
the thread count in the weft is 10 to 40/cm
the warp threads possess a yarn weight of between 40 and 400 dtex
the weft threads possess a yarn weight of between 40 and 660 dtex.

12. Adhesive tape according to claim 1,
wherein
the carrier is a textile carrier and has been provided on the underside with an applied film (film between nonwoven and adhesive).

13. A method of jacketing an elongate item comprising leading an adhesive tape according to claim 1 in a helical line around the elongate item.

14. A method of jacketing an elongate item comprising enveloping the elongate item with an adhesive tape according to claim 1 in the axial direction.

15. Elongate item jacketed with an adhesive tape according to claim 1.
